(19) United States
(12) Patent Application Publication
(10) Pub. No.: US 2005/0089185 A1
(43) Pub. Date: Apr. 28, 2005

(54) Headset ear seal employing phase change material

(76) Inventor: Robin Kelley Allen, Marlborough, MA (US)

Correspondence Address: Attn: William E. Hilton;Samuels, Gauthier & Stevens, LLP, Suite 3300, 225 Franklin Street, Boston, MA, 02110, US

(21) Appl. No.: 10/695,092

(22) Filed: Oct. 28, 2003

(51) Int. Cl. H04R 25/00

(52) U.S. Cl. 381/370; 381/371; 381/374

(57) ABSTRACT

An ear seal is disclosed for use in a headset in which the ear seal includes an inner annular surface and an outer annular surface, wherein the ear seal further includes a thermal storage material proximate the outer annular surface. The thermal storage material is capable of storing thermal energy as latent heat of phase change.

### BACKGROUND OF THE INVENTION

The invention relates to headsets having ear domes adapted to attenuate noise. Such headsets may be used with communication equipment as well as ear protectors and other similar noise attenuating devices. The invention particularly relates to ear seals for use with such headsets.

Headsets typically function by enclosing the ears of a user within ear cups such as plastic domes. Comfortable ear seals are interposed between the ear cups and the user's head to assist in isolating the ears from offending noise originating outside the ear cups. The ear cups are typically attached to a spring and suspension assembly that applies a force urging the ear seals in place against the head of a user. The difficulty in providing improved noise attenuation without detracting from comfort has been long recognized. See for example, U.S. Pat. Nos. 6,163,615; 5,293,647; 4,944,361; 3,571,813 and 2,408,494.

Ear seals that are interposed between the ear cups and the user's head are known to be formed of a variety of foam materials, including sponge plastic and foam rubber (see U.S. Pat. No. 3,593,341), highly compliant foam (see U.S. Pat. No. 4,922,542), polyurethane foam (see U.S. Pat. Nos. 4,958,697, 5,020,163 and 5,148,887) and scythed urethane foam (see U.S. Pat. No. 6,295,366).

Flowable materials such as liquids and semi-solids are also known to be used in ear seals by enclosing the flowable material in a flexible sealed enclosure. Conventional flowable materials used in such ear seals include liquid glycerine (See U.S. Pat. No. 4,674,134), non-liquid silicone gel (see U.S. Pat. No. 4,856,118), and a liquid mixture of dilatent silicone compound and a silicone oil (see U.S. Pat. Nos. 5,138,722, 5,911,314 and 5,821,468).

Conventional ear seals formed of foam and/or flowable materials, however, may not provide sufficient comfort in certain applications, particularly if they trap warm air or moisture against a user's head. Providing an egress for warm air and moisture, however, would detract from the sound attenuation characteristics of the ear seal.

There is a need therefore, for an improved ear seal for headsets that provides sufficient noise attenuation and comfort.

### SUMMARY OF THE INVENTION

The invention provides an ear seal for use in a headset in which the ear seal includes an inner annular surface and an outer annular surface, wherein the ear seal further includes a thermal storage material. The thermal storage material is capable of storing thermal energy as latent heat of phase change. In further embodiments, the thermal storage material is dispersed within a flexible foam material and may include a protective outer material.

### BRIEF DESCRIPTION OF THE ILLUSTRATED EMBODIMENT

The following description may be further understood with reference to the accompanying drawings in which:

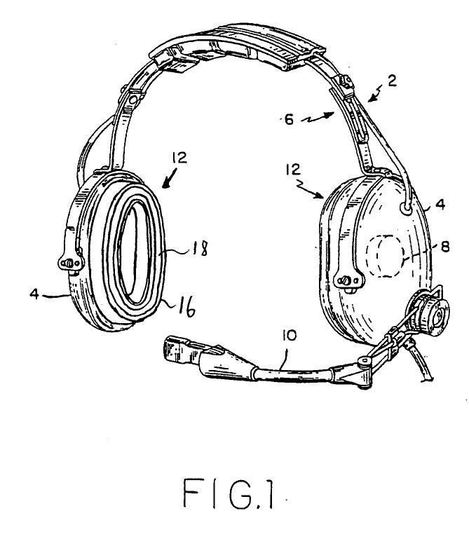

FIG. 1 shows an illustrative diagrammatic isometric view of a headset including an ear seal in accordance with an embodiment of the invention;

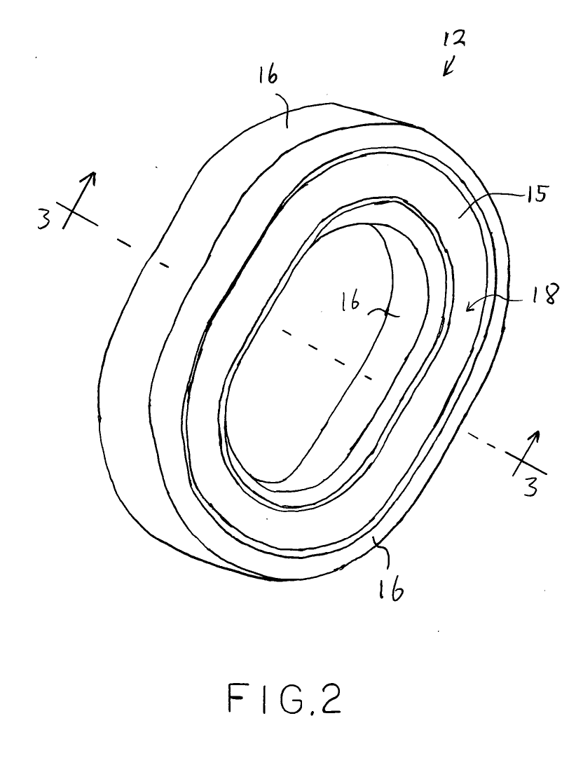

FIG. 2 shows an illustrative diagrammatic isometric view of the ear seal of FIG. 1;

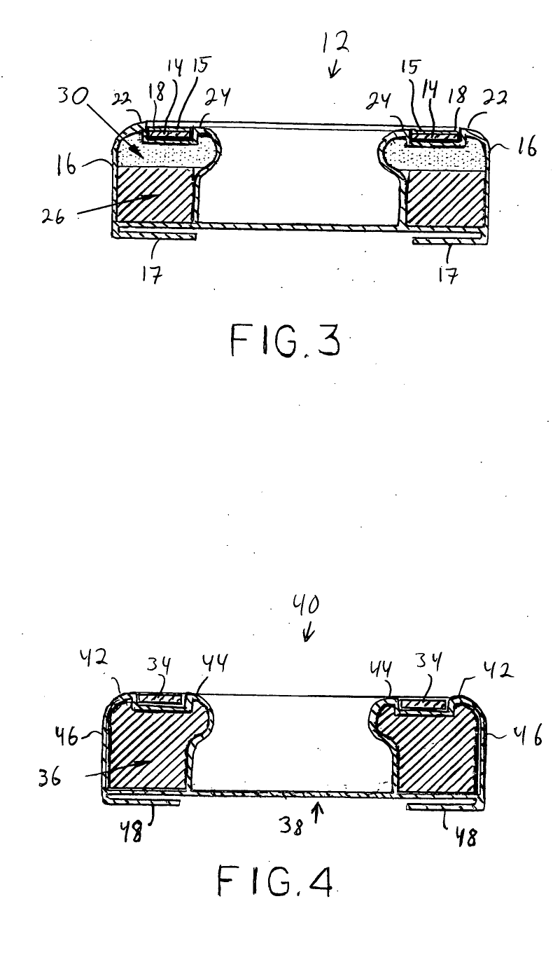

FIG. 3 shows an illustrative diagrammatic sectional side view of the ear seal shown in FIG. 2 taken along line 3-3 thereof; and

FIG. 4 shows an illustrative diagrammatic sectional side view similar to that of FIG. 3 of another ear seal in accordance with a further embodiment of the invention.

The drawings are shown for illustrative purposes only.

### DETAILED DESCRIPTION OF THE ILLUSTRATED EMBODIMENT

Applicant has discovered that certain thermal storage material that is capable of storing thermal energy as latent heat of phase change (e.g., phase change material), may be used with a headset ear seal. Phase change material, typically includes a paraffin wax-like substance that is designed to absorb or release heat energy due to the substance changing phase (e.g., from liquid-to-solid-to-liquid), and having a relatively low melting temperature and a relatively high freezing temperature. This material is known to be used in connection with garments such as wet suits and winter jackets. For example, as a person's body temperature increases, the phase change material should absorb the heat energy by melting the phase change material. When the person's body temperature later cools, the phase change material should release heat energy as the phase change material re-freezes. In this way, the phase change material should help regulate a person's body temperature.

Such phase change material may be provided in garments in a number of ways. For example, U.S. Pat. No. 4,415,222 discloses the use of bulk paraffins as phase change material that is enclosed within sealed pouches 25 that are adapted to be removably inserted into pockets in a garment. U.S. Pat. No. 6,125,645 discloses the use of packaged phase shift material that is provided in relatively small sections that are secured within a breathable garment in a quilt-like fashion. U.S. Pat. No. 6,319,599 discloses the use of phase change material that is distributed within a flexible matrix material such as a flexible polymer or an open cell or open cell polymer foam.

Although noise attenuation and comfort are typically desired in conventional noise attenuation headsets, good noise attenuation often comes with some compromise in comfort. Conversely, many efforts to increase comfort result in an attendant reduction in noise attenuation. Although open cell foam typically provides poor noise attenuation, it has been discovered that an open cell polymer foam that includes phase change material may be used in a headset ear seal without significant loss in noise attenuation in certain conditions.

As shown in FIG. 1, a headset 2 including ear seals 12 in accordance with an embodiment of the invention may include ear cups 4 that are attached to a spring and suspension assembly 6, one or more speakers 8 and a microphone boom assembly 10 for providing communication capabilities. The ear seals 12 may also each include an outer protective cover 16 to which is attached a phase change composite 18.

FIGS. 2 and 3 show isometric and sectional views of the ear seals 12 of FIG. 1. As shown in FIG. 2, each ear seal 12 includes a polyurethane casing 16 and the composite material 18 that includes a flexible foam matrix material 14 (that contains a thermal storage material capable of storing thermal energy as latent heat of phase change), and a fabric cover 15 on the outer surface of the material 14. Such a material 14 may include an open cell polymer foam such as the DRYZ INTELLITEMP™ M foam material sold by Dicon Technologies Corporation of Fair Lawn, N.J. may be used in certain embodiments of the invention. In further embodiments, other paraffin wax like substances may be used that are dispersed within an open cell foam material.

As shown in FIG. 3, the composite 18 may be relatively wide (e.g., about 7-13 mm, and preferably about 10 mm) in comparison to its thickness (e.g., about 1-2 mm, and preferably about 1.5 mm). The composite 18 is also relatively wide with respect to the width of the annular surface of the ear seal (e.g., about 15-20 mm, and preferably about 18 mm) yet is relatively thin compared to the thickness of the ear seal underneath the composite 18 (e.g., about 10-20 mm, and preferably about 14 mm). In various embodiments, the flexible foam material may include an annular width that is about 50% to about 75% (and preferably about 50%) of the annular width of the ear seal, and include a thickness that is about 5% to about 15% (and preferably about 10%) of the annular thickness of the ear seal.

In the present embodiment, the material 18 is also inset from the outer annular surface 20 of the ear seal by a distance of about 1-3 mm, and preferably by a distance of about 2 mm from the radially outer annular circumference of the outer annular surface of the ear seal includes a rim 22. The material 18 is inset from the outer annular surface of the ear seal by a distance of about 1-2 mm, and preferably by a distance of about 1.5 mm from the radially inner annular circumference of the outer annular surface of the ear seal includes a rim 24. The ear seal 12 further includes an open cell foam 26 proximate the inner annular surface 28 of the ear seal, and a flowable material 30 such as a dilatant silicone compound and a silicon oil, both of which are enclosed within an sheath 32. The cover 16 also includes an integral flap 17 for engaging an annular flange on a headset dome.

As shown in FIG. 4, ear seals in accordance with another embodiment of the invention may include a phase change material 34 and an open cell foam 36 that extends from the inner annular surface 38 to the outer annular surface 40. In further embodiments, the ear seal may include a flowable material only and no foam material other than the phase change material 34. As also shown in FIG. 4, the ear seal may include raised rims 42 and 44 that both extend beyond the surface of the phase change material 34. The ear seal shown in FIG. 4 also includes an outer protective cover 46 that encloses the foam 38 and onto which the material 34 is attached. The sheath 46 includes an annular flap 48 for engaging an annular flange on a headset ear dome.

Those skilled in the art will appreciate that numerous modifications and variations may be made to the above disclosed embodiments without departing from the spirit and scope of the invention.

1. An ear seal for use in a headset, said ear seal comprising an inner annular surface, and an outer annular surface, said ear seal further including a thermal storage medium proximate said outer annular surface.

2. The ear seal as claimed in claim 1, wherein said thermal storage material includes paraffin wax-like substance.

3. The ear seal as claimed in claim 1, wherein said ear seal further includes a flexible sheath onto which the thermal storage medium is attached.

4. The ear seal as claimed in claim 1, wherein said thermal storage material is dispersed within a flexible foam matrix.

5. The ear seal as claimed in claim 4, wherein said flexible foam matrix material is relatively wide with respect to a width of the ear seal and is relatively thin with respect to a thickness of the ear seal.

6. The ear seal as claimed in claim 4, wherein said flexible foam matrix material is inset from said outer annual surface of said ear seal.

7. The ear seal as claimed in claim 4, wherein said outer annular surface of said ear seal extends beyond said flexible foam material along at least one annular surface of said ear seal.

8. The ear seal as claimed in claim 4, wherein said flexible foam material forms an annular ring that is intermediate a radially inner annular surface and a radially outer annular surface of said ear seal.

9. The ear seal as claimed in claim 1, wherein said thermal storage material includes a flexible foam material and a protective cover on at least one side of said flexible foam material.

10. An ear seal for use in a headset, said ear seal comprising an inner annular surface for contacting a headset, and an outer annular surface for contacting a user's head, said ear seal further including a flexible foam matrix material proximate said outer annular surface, and said flexible foam matrix material containing a thermal storage material capable of storing thermal energy as latent heat of phase change.

11. The ear seal as claimed in claim 10, wherein said ear seal further includes a flexible outer sheath enclosing said flexible foam material.

12. The ear seal as claimed in claim 10, wherein said flexible foam matrix material is inset from said outer annual surface of said ear seal.

13. The ear seal as claimed in claim 10, wherein said flexible foam material forms an annular ring.

14. The ear seal as claimed in claim 13, wherein said flexible foam material is positioned intermediate a radially inner edge of said ear seal and a radially outer edge of said ear seal.

15. The ear seal as claimed in claim 10, wherein said flexible foam material is relatively thin with respect to its width.

16. An ear seal for use in a headset, said ear seal comprising an inner annular surface, and an outer annular surface, an annular width and an annular thickness, said ear seal further including a flexible foam matrix material proximate said outer annular surface, and said flexible foam matrix material containing a thermal storage material capable of storing thermal energy as latent heat of phase change, said flexible foam material further including an annular width that is about 50% to about 75% of the annular width of said ear seal, and including a thickness that is about 5% to about 15% of the annular thickness of said ear seal.
